(19) United States
(12) Patent Application Publication
(10) Pub. No.: US 2025/0315962 A1
(43) Pub. Date: Oct. 9, 2025

(54) IMAGE PROCESSING APPARATUS AND ANGLE MEASUREMENT METHOD IN DYNAMIC IMAGE

(71) Applicant: Konica Minolta, Inc., Tokyo (JP)

(72) Inventor: Takahisa UEHARA, Kanagawa (JP)

(21) Appl. No.: 19/096,872

(22) Filed: Apr. 1, 2025

(30) Foreign Application Priority Data
Apr. 4, 2024 (JP) 2024-060903

(51) Int. Cl. G06T 7/246; G06T 7/00; G06T 7/33; G06T 11/20

(52) U.S. Cl. CPC G06T 7/248; G06T 7/0016; G06T 7/337; G06T 11/203; G06T 2207/30004

(57) ABSTRACT

An image processing apparatus according to the present disclosure includes: an acquirer acquiring a dynamic image; a setter setting a direction of angle measurement in the dynamic image; and a measurer measuring, in each of a plurality of frame images included in the dynamic image, an angle formed by a reference line serving as a reference for the angle measurement and a line segment including a measurement target point serving as a target for the angle measurement in the direction set by the setter.

### CROSS REFERENCE TO RELATED APPLICATIONS

The present invention claims priority under 35 U.S.C. § 119 to Japanese Patent Application No. 2024-060903 filed on Apr. 4, 2024, the entire contents of which is being incorporated herein by reference.

### BACKGROUND

### Technological Field

The present disclosure relates to an image processing apparatus and an angle measurement method in a dynamic image.

### Description of Related Art

A technology has been proposed in which a user such as a doctor makes a diagnosis using a dynamic image acquired by imaging a dynamic state of an object.

For example, Japanese Unexamined Patent Publication No. 2023-026878 discloses a technique of receiving designation of a region or a point on a locomotor in a dynamic image in which the motion of the locomotor is captured, aligning a line segment connecting the regions or the points based on a set alignment reference, and displaying the line segment superimposed on a representative frame image of the dynamic image.

### SUMMARY

Japanese Unexamined Patent Publication No. 2023-026878 discloses that two or more line segments connecting a plurality of areas or points are used to measure an angle between the line segments. As a result, it is possible to easily recognize, based on the dynamic image, in what relationship the structures included in the locomotor shown in the dynamic image are moving.

In measurement of a structure included in a dynamic image, there is a demand for more easily designating the structure whose angle is to be measured. In addition, in measurement related to a structure shown in a dynamic image, there is a demand for more accurate angle measurement regardless of the movement of the structure.

An object of the present disclosure is to provide an image processing apparatus and an angle measurement method in a dynamic image, which are capable of accurately performing angle measurement on a structure shown in the dynamic image.

To achieve at least one of the abovementioned objects, an image processing apparatus according to an aspect of the present invention includes a hardware processor configured to: acquire a dynamic image; perform setting of a direction of angle measurement in the dynamic image; and perform, in each of a plurality of frame images included in the dynamic image, measurement of an angle formed by a reference line and a line segment in the direction set by the setting, the reference line serving as a reference of the angle measurement, the line segment including a measurement target point serving as a target of the angle measurement.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating a configuration example of a radiographic imaging system;

FIG. 2 is a block diagram illustrating an example of a configuration of the image processing apparatus;

FIG. 3 is a functional block diagram illustrating a functional configuration of the image processing apparatus;

FIG. 4 is a flowchart for explaining an operation example of angle measurement process by the image processing apparatus;

FIG. 5 is a diagram illustrating a display example of a dynamic image, an angle measurement direction, a reference point, a reference line, and a measurement target point; and

FIGS. 6A to FIG. 6H are diagrams showing examples of combinations of a reference direction in which a reference line extends from a reference point and an angle measurement direction, and examples of angle measurement results in the respective combinations.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, each embodiment of the present disclosure will be described in detail with reference to the drawings. However, unnecessarily detailed description, for example, detailed description of already well-known matters, redundant description of substantially the same configuration, and the like may be omitted. However, the scope of the present invention is not limited to the following embodiments and drawings.

### Configuration of Radiographic Imaging System 1

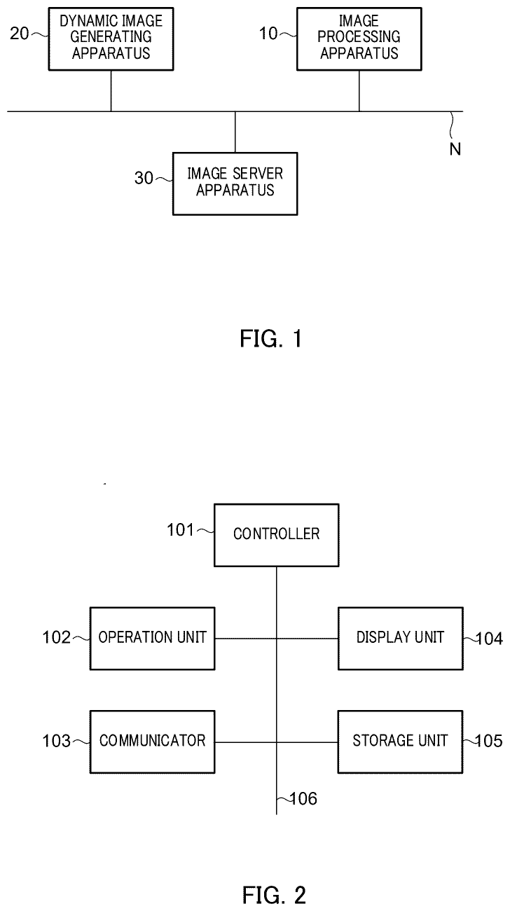

A schematic configuration of a radiographic imaging system 1 according to an embodiment of the present disclosure will be described. FIG. 1 is a block diagram illustrating an example of the configuration of a radiographic imaging system 1.

As illustrated in FIG. 1, the radiographic imaging system 1 includes an image processing apparatus 10, a dynamic image generating apparatus 20, and an image server apparatus 30. These components are communicably connected to each other via a communication network N. The communication network N is, for example, a network compliant with the digital image and communications in medicine (DICOM) standard.

Note that the radiographic imaging system 1 may be connected to an external system such as a hospital information system (HIS) or a radiology information system (RIS), in addition to the configuration illustrated in FIG. 1.

The dynamic image generating apparatus 20 continuously irradiates a subject (e.g., a patient) with radiation (e.g., X-rays), detects the radiation that has passed through the subject, and generates dynamic images on the basis of the elapsed time and the intensity of the radiation. In the present specification, a dynamic image is a moving image representing the movement of the subject, and in particular, a moving image representing the movement of a locomotor of the subject. The dynamic image includes a plurality of frame images captured along a time series. Therefore, the dynamic image can represent a state in which locomotor of the subject, for example, a shoulder, a neck, an elbow, a knee, a waist, a wrist, an ankle, or the like is moving.

The dynamic image generating apparatus 20 operates on the basis of, for example, an operation by a radiographer or the like, a preset imaging condition, and the like. The imaging conditions include radiation irradiation conditions, image generation conditions, object conditions, and the like. The radiation irradiation condition indicates, for example, a pulse rate, a pulse width, a pulse interval, the number of imaging frames per imaging, and a dose per unit time of radiation irradiation. The image generation condition indicates an image generation condition such as a frame rate, a frame interval, a pixel size, and an image size. The object condition indicates information on the subject (e.g., identification information of the object), the type of locomotor to be imaged (e.g., shoulder, elbow, waist, and the like), and the like.

The dynamic image generating apparatus 20 may be, for example, an apparatus installed in an imaging room or the like, or may be a movable apparatus mounted on a medical cart or the like.

The dynamic image generating apparatus 20 transmits the generated dynamic images to the image processing apparatus 10 and the image server apparatus 30. At this time, the dynamic image generation device 20 may transmit supplementary information including information relating to the object appearing in the dynamic image, the type of locomotor appearing in the dynamic image, the imaging date and time, and the like together with the dynamic image or by embedding the supplementary information in the dynamic image.

The image processing apparatus 10 receives the dynamic images from the dynamic image generating apparatus 20 and performs various types of image processing on the dynamic images. The image processing apparatus 10 is a computer including a tablet terminal, a personal computer (PC), a workstation, or a dedicated hardware device.

The image server apparatus 30 stores and manages the dynamic images received from the dynamic image generating apparatus 20 or the image processing apparatus 10 in association with the supplementary information. In response to a request from the image processing apparatus 10, the image server apparatus 30 transmits the dynamic images to be stored to the image processing apparatus 10. The image server apparatus 30 includes a PC, a workstation, a dedicated hardware device, and a virtual server on a cloud.

FIG. 1 illustrates an example in which the radiographic imaging system 1 includes the image server apparatus 30 provided independently of the dynamic image generating apparatus 20 or the image processing apparatus 10. The present disclosure is not limited thereto, and for example, a database that stores and manages dynamic images may be provided in the dynamic image generating apparatus 20 or the image processing apparatus 10. Alternatively, for example, dynamic images may be transmitted to an external system such as a picture archiving and communication system (PACS), so that the PACS stores and manages the dynamic images.

### Configuration of Image Processing Apparatus 10

FIG. 2 is a block diagram illustrating an example of a configuration of the image processing apparatus 10.

As illustrated in FIG. 2, the image processing apparatus 10 according to the present embodiment includes a controller 101, an operation unit 102, a communication unit 103, a display unit 104, and a storage unit 105. These components are electrically connected to one another by a bus 106.

The controller 101 includes a central processing unit (CPU) and a random access memory (RAM). The CPU of the controller 101 reads various programs stored in the storage unit 105, develops the programs in the RAM, and executes various processes according to the developed programs. Thus, the controller 101 centrally controls the operation of each part of the image processing apparatus 10.

The operation unit 102 is a device that receives a user operation. The operation unit 102 is constituted by a keyboard, a pointing device (for example, a mouse or a trackball), a touch pad, or the like. The operation unit 102 outputs, to the controller 101, a control signal responsive to a user operation.

Note that in the present embodiment, the user includes, for example, a doctor who makes a diagnosis or the like using the dynamic images generated by the dynamic image generating apparatus 20, or a radiographer who operates the dynamic image generating apparatus 20 to generate dynamic images.

The communication unit 103 communicates with other components of the radiographic imaging system 1 via the communication network N illustrated in FIG. 1.

The display unit 104 is a display device such as a liquid crystal display (LCD), an organic electro luminescence (EL) display, or a cathode ray tube (CRT) display. The display unit 104 displays a dynamic image, various measurement results in the dynamic image, and the like based on a control signal input from the controller 101.

The storage unit 105 stores various programs executed by the controller 101, parameters necessary for the execution of the programs, and the like. Further, the storage unit 105 may be capable of storing a dynamic image. The storage unit 105 includes, for example, a non-volatile semiconductor memory, a hard disk drive (HDD), or a solid state drive (SDD).

### Operation of Image Processing Apparatus 10

With the above-described configuration, the image processing apparatus 10 can execute a measurement process of performing various kinds of measurement on the locomotor shown in the dynamic image using the dynamic image received from the dynamic image generating apparatus 20. The measurement process includes, for example, an angle measurement process, a distance measurement process, and a speed measurement process. The angle measurement process is a process of measuring an angle formed by a reference line extending from a reference point in the dynamic image and a line segment including a measurement target point on a structure constituting the locomotor. The distance measurement process is a process of measuring a distance between specific points on the structure. The speed measurement process is a process of measuring a speed at which a specific point of the structure information moves. The measurement process performed by the image processing apparatus 10 may include a measurement process other than the above.

In the following, the operation of the image processing apparatus 10 particularly when executing the angle measurement process will be described in detail.

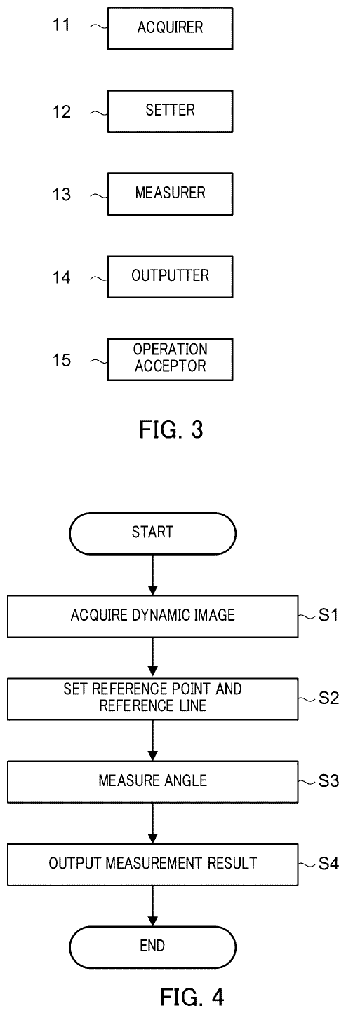

FIG. 3 is a functional block diagram illustrating a functional configuration of the image processing apparatus 10 implemented by a controller 101 illustrated in FIG. 2. The image processing apparatus 10 includes, as functional components, an acquirer 11, a setter 12, a measurer 13, an outputter 14, and an operation acceptor 15.

The acquirer 11 acquires a dynamic image and the supplementary information transmitted from the dynamic image generating apparatus 20.

The setter 12 sets the angle measurement direction, the position of the reference point, the direction of the reference line, and the position of the measurement target point with respect to one dynamic image to be subjected to the angle measurement process. The angle measurement direction indicates a direction in which an angle is measured in the angle measurement process. Specifically, the angle measurement direction indicates whether an angle is measured in a clockwise direction or a counterclockwise direction. The reference line is a line serving as a reference for angle measurement. The reference line is a line extending from a reference point in the dynamic image in a reference direction that is 0° in angle measurement. The reference point is a starting point from which a reference line extends. The measurement target point is a point indicating a specific position of a locomotor whose angle is to be measured.

The setting by the setter 12 is automatically applied to all the frame images of the dynamic image. Accordingly, it is not necessary to perform the setting related to the angle measurement process for each frame image, and the time and effort required for the setting is reduced.

The measurer 13 measures an angle formed by the reference line and a line segment including the measurement target point in the direction set by the setter in each of the plurality of frame images included in the dynamic image. The line segment including a measurement target point on the locomotor is, for example, a line segment connecting the measurement target point and the reference point.

The outputter 14 outputs reference information indicating the reference point and the reference line in association with the dynamic image. Further, the outputter 14 outputs angle information indicating the measured angle in association with the corresponding frame image. The information output by the outputter 14 is displayed on, for example, the display unit 104 illustrated in FIG. 2. Alternatively, the information output by the outputter 14 is stored in the image server apparatus 30 illustrated in FIG. 1 in association with the dynamic image.

The operation acceptor 15 accepts a user operation via the operation unit 102.

FIG. 4 is a flowchart illustrating an operation example of the angle measurement process by the image processing apparatus 10. FIG. 4 illustrates an operation example in a case where the image processing apparatus 10 performs the angle measurement process using one dynamic image newly generated by the dynamic image generating apparatus 20.

In step S1, the acquirer 11 acquires a dynamic image and supplementary information. The dynamic image acquired by the acquirer 11 is output by the outputter 14 and displayed on the display unit 104. The display of the dynamic image on the display unit 104 may be performed while the angle measurement process illustrated in FIG. 4 is being executed.

In step S2, the setter 12 sets an angle measurement direction, the position of a reference point, the direction of a reference line, and the position of a measurement target point for angle measurement process.

The setter 12 may set the angle measurement direction, the position of the reference point, the direction of the reference line, and the position of the measurement target point based on, for example, an operation performed by the user via the operation unit 102 while viewing the dynamic image displayed on the display unit 104. Alternatively, the setter 12 may automatically set the angle measurement direction, the position of the reference point, the direction of the reference line, and the position of the measurement target point on the basis of supplementary information including information regarding the locomotor. Alternatively, the setter 12 may automatically perform the setting and then correct the setting based on an operation by the user. The setter 12 does not have to automatically set all of the angle measurement direction, the position of the reference point, the direction of the reference line, and the position of the measurement target point, but automatically sets at least a part of the angle measurement direction, the position of the reference point, the direction of the reference line, and the position of the measurement target point, and the remainder may be set based on a user's operation.

When the setter 12 automatically sets the angle measurement direction, the position of the reference point, the direction of the reference line, and the position of the measurement target point, reference information serving as a reference for the setting is determined in advance and stored in the storage unit 105 (see FIG. 2). The reference information is, for example, information indicating the angle measurement direction, the positions of the reference point and the measurement target point on the structure of a locomotor, and the direction of the reference line, which are set in advance for each type of locomotor. The setter 12 may automatically set the position of the reference point, the direction of the reference line, and the position of the measurement target point by reading the initial information corresponding to the type of locomotor indicated by the supplementary information from the storage unit 105. Furthermore, after automatically setting the position of the reference point, the direction of the reference line, and the position of the measurement target point, the setter 12 may automatically set the angle measurement direction such that the measured angle does not exceed 180°.

The angle measurement direction, the position of the reference point, the direction of the reference line, and the position of the measurement target point set in step S2 are reflected by being displayed by the outputting unit 14 so as to be superimposed on the dynamic image displayed on the display unit 104. In a case where the user sets the angle measurement direction, the position of the reference point, the direction of the reference line, and the position of the measurement target point via the operation unit 102, the outputter 14 may change the angle measurement direction, the positions of the reference point and the measurement target point, and the direction in which the reference line extends, which are displayed on the dynamic image, based on the operation received by the operation acceptor 15. Accordingly, the user can set the angle measurement direction, the position of the reference point, the direction of the reference line, and the position of the measurement target point by an intuitive operation.

As described above, the angle measurement direction indicates a direction in which an angle is measured in the angle measurement process, and specifically indicates whether the angle is measured in a clockwise direction or a counterclockwise direction.

The reference point is a point indicating a position serving as a reference when angle measurement of the measurement target point is performed. The reference point may be set at one point of the locomotor, or may be set at one point in the dynamic image independently of the locomotor. When the reference point is set at one point of the locomotor, the position of the reference point in the dynamic image can move for each frame image in accordance with the motion of the locomotor. On the other hand, when the reference point is set independently of the locomotor, the position of the reference point in each frame image constituting the dynamic image is the same position.

The reference line is a line extending from a reference point in a particular reference direction and indicates 0° in the angle measurement process. In the present embodiment, the reference direction is any one of a right direction, a left direction, an up direction, and a down direction with reference to up, down, left, and right directions of the dynamic image. That is, when the measurement target point is on the reference line, the measurement result of the angle is 0°.

The measurement target point is a point indicating a specific position of a locomotor whose angle is to be measured. That is, since the measurement target point is one point of a locomotor shown in a dynamic image, the position of the measurement target point in the dynamic image can move for each frame image in accordance with the motion of the locomotor.

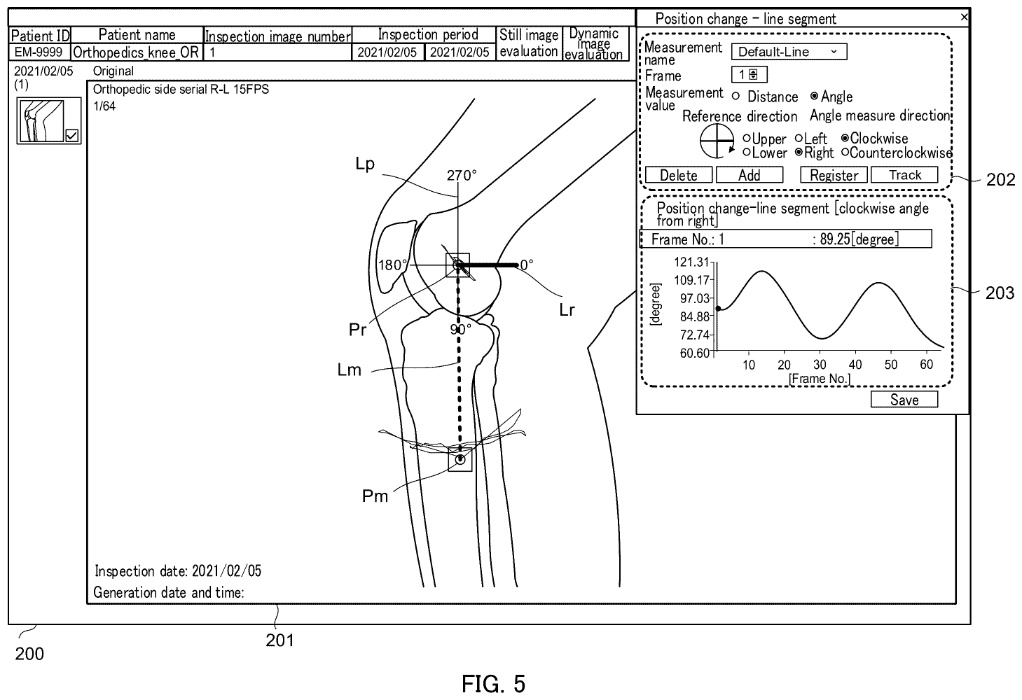

FIG. 5 is a diagram illustrating a display example of a dynamic image, an angle measurement direction, a reference point, a reference line, and a measurement target point. FIG. 5 illustrates an example of a screen on which the reference point Pr, the reference line Lr, the measurement target point Pm, and the angle presentation line Lp for indicating the angle measurement direction are superimposed and displayed on the dynamic image. FIG. 5 illustrates a screen 200 displayed on the display unit 104 based on the information output by the outputter 14.

As illustrated in FIG. 5, the screen 200 includes a dynamic image display region 201, a setting field 202, and a measurement result display field 203. In the example illustrated in FIG. 5, an image of one frame of dynamic images in which a knee as an example of the locomotor is captured from the side of the body is illustrated.

In the example illustrated in FIG. 5, the angle measurement direction is set to be clockwise. That is, when the angle measurement process is performed on the dynamic image illustrated in FIG. 5, the angle increases clockwise with the right direction of the dynamic image as 0°. The reference point Pr is set at a distal portion of the femur. The measurement target point Pm is set at a position slightly lower than the upper end of the tibia. The reference line Lr is set so as to extend rightward from the reference point Pr.

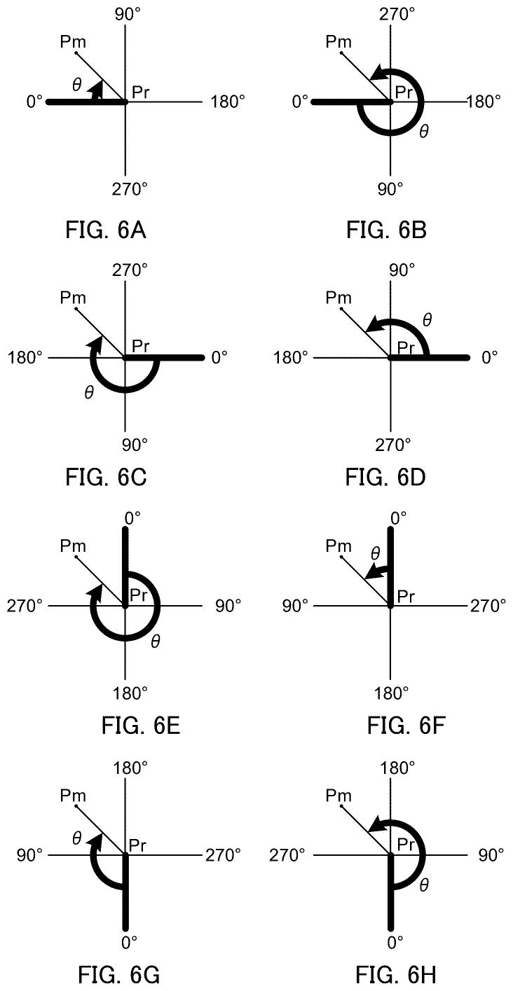

In the example illustrated in FIG. 5, in addition to the reference line Lr, relatively thin angle presentation lines Lp for indicating the angle measurement direction extend from the reference point Pr in the left direction, the upper direction, and the lower direction. It is desirable that the reference line Lr be displayed thicker than the angle presentation lines Lp so that the user can easily recognize the specific direction serving as a reference for angle measurement. Furthermore, in the example illustrated in FIG. 5, an angle is indicated in proximity to each angle presentation line Lp. In the example illustrated in FIG. 5, the downward direction is 90°, the leftward direction is 180°, and the upward direction is 270°. The angle measurement direction may be displayed in the form of an arrow, for example, as illustrated in FIG. 6 to be described below, in addition to the display form illustrated in FIG. 5.

The reference direction in which the reference line Lr extends from the reference point Pr and the angle measurement direction illustrated in FIG. 5 are examples, and in the present disclosure, the reference direction in which the reference line Lr extends from the reference point Pr and the angle measurement direction can be freely set.

FIGS. 6A to FIG. 6H illustrate examples of combinations of a reference direction in which a reference line Lr extends from a reference point Pr and an angle measurement direction, and examples of angle measurement results in the combination, respectively. FIG. 6A illustrates an example of a case where the reference direction in which the reference line Lr extends from the reference point Pr is the left direction and the angle measurement direction is the clockwise direction. FIG. 6B illustrates an example of a case where the reference direction in which the reference line Lr extends from the reference point Pr is the left direction and the angle measurement direction is the counterclockwise direction. FIG. 6C illustrates an example of a case where the reference direction in which the reference line Lr extends from the reference point Pris the right direction and the angle measurement direction is the clockwise direction. FIG. 6D illustrates an example of a case where the reference direction in which the reference line Lr extends from the reference point Pr is the right direction and the angle measurement direction is the counterclockwise direction. FIG. 6E illustrates an example of a case where the reference direction in which the reference line Lr extends from the reference point Pr is the upward direction and the angle measurement direction is the clockwise direction. FIG. 6F illustrates an example of a case where the reference direction in which the reference line Lr extends from the reference point Pris the upward direction and the angle measurement direction is the counterclockwise direction. FIG. 6G illustrates an example of a case where the reference direction in which the reference line Lr extends from the reference point Pr is the downward direction and the angle measurement direction is the clockwise direction. FIG. 6H illustrates an example of a case where the reference direction in which the reference line Lr extends from the reference point Pr is a downward direction and the angle measurement direction is a counterclockwise direction.

Note that although the reference direction is 0° and measurement is possible up to 360° according to the angle measurement direction in the examples illustrated in FIG. 5 and FIG. 6, the present disclosure is not limited thereto. For example, the reference direction may be an angle other than 0°, such as −90°. In this case, it is possible to measure up to 270° according to the secured measurement direction.

Return to the description of FIG. 5. The setting field 202 is a field in which a display object for the user to make various settings for the angle measurement process is displayed. In the example illustrated in FIG. 5, the setting field 202 includes a display object for setting a reference direction and a display object for setting an angle measurement direction. The user can easily set the reference direction and the angle measurement direction by, for example, selecting a desired place in the setting field 202 via the operation unit 102 (see FIG. 2). The reference point Pr and the measurement target point Pm may be set by the user directly moving the reference point Pr and the measurement target point Pm displayed in the dynamic image display region 201 by an operation via the operation unit 102.

The measurement result display field 203 will be described below.

Return to the description of FIG. 4. In step S3, the measurer 13 measures, for all the frame images included in the dynamic image, an angle formed by the reference line and the line segment connecting the reference point and the measurement target point. The measurer 13 causes the storage unit 105 (see FIG. 2) to store measurement result information indicating the measurement result.

As illustrated in FIG. 6, the measurer 13 measures an angle in accordance with the set direction of the reference line and the angle measurement direction. In the example illustrated in FIG. 5, the angle θ formed by the line segment Lm connecting the reference point Pr and the measurement target point Pm and the reference line Lr is measured to be about 90°.

In step S4, the outputter 14 outputs the measurement results of the angles in all the frame images. The outputter 14 may output, for example, each frame image in association with a corresponding measurement result. Further, the outputter 14 may output changes in the angle measurement results of all the frame images included in the dynamic image in a graph format.

A measurement result display field 203 in FIG. 5 shows a display example of the measurement result. In the example illustrated in FIG. 5, the measurement result display field 203 includes an angle measurement result (89.25 degree in the example illustrated in FIG. 5) in the dynamic image currently displayed on the screen 200 and a graph indicating a change in the angle measurement result in all frame images included in the dynamic image. In this way, not only the angle measurement result in the displayed frame image, but also the change in the angle measurement results in all the frame images included in the dynamic image is illustrated in a graph form, and thus the user can intuitively recognize what kind of movement the locomotor shown in the dynamic image is performing.

The operation example in the case where the angle measurement process is performed using one dynamic image newly generated by the dynamic image generating apparatus 20 has been described above. As another operation example, for example, when a dynamic image is newly acquired, the image processing apparatus 10 may generate a measurement result of the new dynamic image, read an angle measurement result related to a past dynamic image obtained by imaging the same locomotor of the same patient from the storage unit 105 or the like, and output the new measurement result and the past measurement result in a form in which they can be compared with each other. Specifically, for example, a graph indicating a past measurement result and a graph indicating a new measurement result may be displayed side by side.

For example, at least one of the position of the reference point, the reference direction of the reference line, and the angle measurement direction may be different between the angle measurement process using the past dynamic image and the angle measurement process using the new dynamic image. In such a case, the acquirer 11 of the image processing apparatus 10 further acquires a past dynamic image of the same subject and past setting serving as a reference for angle measurement in the past dynamic image. Then, the measurer 13 newly performs the angle measurement process of a new dynamic image using the past setting. Thus, since the result of angle measurement performed with the same setting content can be compared between the past dynamic image and the new dynamic image, a change from the movement of the locomotor of the subject with the lapse of time can be more accurately diagnosed. The measurer 13 may perform the angle measurement process again on the past dynamic image using the setting related to the angle measurement process of the new dynamic image set by the setter 12.

### Actions and Effects

As described above, the image processing apparatus 10 according to the embodiment of the present disclosure includes the acquirer 11 that acquires a dynamic image, the setter 12 that sets a direction of angle measurement in the dynamic image, and the measurer 13 that measures an angle formed by a reference line (that serves as a reference of the angle measurement) and a line segment (that includes a measurement target point serving as a target of the angle measurement) in the direction set by the setter 12, in each of a plurality of frame images included in the dynamic image.

According to such a configuration, in angle measurement using a dynamic image, it is possible to perform angle measurement process in a desired angle measurement direction and to suppress a situation in which an angle not intended by the user is measured.

Further, with the image processing apparatus 10 according to the embodiment of the present disclosure, the setter 12 further sets the position of the reference point, the direction of the reference line, and the position of the measurement target point. This makes it possible to accurately set, for each dynamic image, a reference point and a reference line serving as a reference for angle measurement, and a measurement target point serving as a target for angle measurement set inside the locomotor. Therefore, it is possible to accurately measure the angle of the locomotor shown in the dynamic image.

Furthermore, with the image processing apparatus 10 according to the embodiment of the present disclosure, the setter 12 makes the setting to be applied to all the frame images in the dynamic image.

With such a configuration, it is not necessary to perform setting for each frame image, and thus it is possible to reduce time and effort for setting.

Furthermore, the image processing apparatus 10 according to the embodiment of the present disclosure further includes the operation acceptor 15 that accepts an operation input for the setting of the setter 12.

With such a configuration, the user can perform setting for the angle measurement process with a simple operation.

In addition, with the image processing apparatus 10 according to the embodiment of the present disclosure, the acquirer 11 further acquires supplementary information regarding the locomotor shown in the dynamic image, and the setter 12 performs the setting based on the supplementary information.

According to such a configuration, since the setter 12 automatically performs the setting on the basis of the supplementary information, it is possible to reduce the labor of the setting by the user.

Furthermore, the image processing apparatus 10 according to the embodiment of the present disclosure further includes the outputter 14 that outputs the reference information indicating the reference point and the reference line in association with the dynamic image.

With such a configuration, the user can accurately recognize the angle measurement result.

Furthermore, with the image processing apparatus 10 according to the embodiment of the present disclosure, the outputter 14 outputs the angle information indicating the measured angle in association with the corresponding frame image.

With such a configuration, the user can easily grasp the angle measurement result in the displayed dynamic image.

Furthermore, with the image processing apparatus 10 according to the embodiment of the present disclosure, the acquirer 11 further acquires a past dynamic image of the same subject and past setting that serves as a reference for angle measurement in the past dynamic image, and the measurer 13 performs measurement on a new dynamic image on the basis of the past dynamic image and the past setting.

Alternatively, in the image processing apparatus 10 according to the embodiment of the present disclosure, the measurer 13 measures the angle in each of the dynamic image and the past dynamic image based on the setting by the setter 12.

Furthermore, with the image processing apparatus 10 according to the embodiment of the present disclosure, the outputter 14 outputs the result of the measurement based on the dynamic image and the result of the measurement based on the past dynamic image in association with each other.

With such a configuration, it is possible to accurately diagnose the influence of the passage of time on the same locomotor of the same subject.

### Modification Example

The above-described embodiment is merely an example of the present disclosure, and the present disclosure can take various modification examples. In the above-described embodiment, the image processing apparatus 10 acquires a dynamic image in which a locomotor is shown, and performs measurement processing using the dynamic image. The present disclosure is not limited thereto and can be applied to an image processing apparatus that handles a dynamic image other than a dynamic image in which a locomotor appears.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus comprising a hardware processor configured to:
acquire a dynamic image;
perform setting of a direction of angle measurement in the dynamic image; and
perform, in each of a plurality of frame images included in the dynamic image, measurement of an angle formed by a reference line and a line segment in the direction set by the setting, the reference line serving as a reference of the angle measurement, the line segment including a measurement target point serving as a target of the angle measurement.

2. The image processing apparatus according to claim 1, wherein
the hardware processor is further configured to perform setting of a position of a reference point that is a starting point from which the reference line extends, a direction of the reference line, and a position of the measurement target point.

3. The image processing apparatus according to claim 1, wherein
the hardware processor is further configured to perform the setting to be applied to all of the plurality of frame images in the dynamic image.

4. The image processing apparatus according to claim 1, wherein
the hardware processor is configured to accept an operation input for the setting.

5. The image processing apparatus according to claim 1, wherein
the hardware processor is further configured to:
acquire supplementary information related to a locomotor shown in the dynamic image; and
perform the setting based on the supplementary information.

6. The image processing apparatus according to claim 1, wherein
the hardware processor is further configured to output a reference point and reference information in association with the dynamic image, the reference point being a starting point from which the reference line extends, the reference information indicating the reference line.

7. The image processing apparatus according to claim 6, wherein
the hardware processor is further configured to output angle information indicating the measured angle in association with a frame image of the plurality of frame images, the frame image corresponding to the angle information.

8. The image processing apparatus according to claim 1, wherein:
the hardware processor is further configured to:
acquire a past dynamic image of a subject that is identical with a subject having a locomotor shown in the dynamic image, and past setting serving as a reference of angle measurement in the past dynamic image; and
perform the measurement for the dynamic image based on the past dynamic image and the past setting.

9. The image processing apparatus according to claim 8, wherein
the hardware processor is further configured to measure, based on the setting, the angle in each of the dynamic image and the past dynamic image.

10. The image processing apparatus according to claim 8, wherein
the hardware processor is further configured to output a result of the measurement based on the dynamic image and a result of the measurement based on the past dynamic image in association with each other.

11. A method of measuring an angle in a dynamic image, the method comprising:
acquiring the dynamic image;
setting a direction of angle measurement in the dynamic image; and
measuring, in each of a plurality of frame images included in the dynamic image, an angle formed by a reference line and a line segment in the set direction, the reference line serving as a reference of the angle measurement, the line segment including a measurement target point serving as a target of the angle measurement.
